(19) United States
(12) Patent Application Publication
(10) Pub. No.: US 2026/0019512 A1
(43) Pub. Date: Jan. 15, 2026

(54) DETECTION DEVICE

(71) Applicant: Japan Display Inc., Tokyo (JP)

(72) Inventors: Chiehan CHIEN, Tokyo (JP); Takayuki FUJIOKA, Tokyo (JP); Tenfu NAKAMURA, Tokyo (JP)

(21) Appl. No.: 19/261,164

(22) Filed: Jul. 7, 2025

(30) Foreign Application Priority Data
Jul. 9, 2024 (JP) 2024-110460

(51) Int. Cl. H04N 1/00; G09B 21/00

(52) U.S. Cl. CPC H04N 1/00488; G09B 21/006; H04N 1/00411; H04N 1/00824

(57) ABSTRACT

According to an aspect, a detection device includes: a light-transmitting optical sensor in which a plurality of sensor pixels are arranged in a planar configuration; and a processing circuit configured to acquire an image on a sheet-like medium in contact with or in proximity to one surface of the optical sensor and generate sound information based on the image.

### CROSS-REFERENCE TO RELATED APPLICATION

This application claims the benefit of priority from Japanese Patent Application No. 2024-110460 filed on Jul. 9, 2024, the entire contents of which are incorporated herein by reference.

### BACKGROUND

### 1. Technical Field

What is disclosed herein relates to a detection device.

### 2. Description of the Related Art

Technologies that combine optical character recognition (OCR) with voice synthesis have conventionally been developed (for example, Japanese Patent Application Laid-open Publication No. H11-355627). With such technologies, a document printed on a paper medium is captured using a camera or a scanner and converted into electronic data, and characters included in the captured image are recognized and output by voice using an earphone or a speaker. These technologies are said to allow visually impaired people to recognize printed documents on their own.

However, in order to convert the printed document into electronic data in the conventional technologies mentioned above, the document printed on the paper medium in advance needs to be captured by the camera or the scanner, which basically involves considerable difficulties for the visually impaired people to convert the printed document into electronic data. In addition, the printed document including less useful texts and illustrations, such as headers and footers, needs to be acquired as image information and stored in advance.

For the foregoing reasons, there is a need for a detection device capable of more easily converting a printed document into sound and outputting the sound.

### SUMMARY

According to an aspect, a detection device includes: a light-transmitting optical sensor in which a plurality of sensor pixels are arranged in a planar configuration; and a processing circuit configured to acquire an image on a sheet-like medium in contact with or in proximity to one surface of the optical sensor and generate sound information based on the image.

### BRIEF DESCRIPTION OF THE DRAWINGS

FIG. 1 is a plan view schematically illustrating a detection device according to a first embodiment of the present disclosure;

FIG. 2 is a sectional view schematically illustrating the detection device according to the first embodiment;

FIG. 3 is a block diagram illustrating a configuration example of a processing circuit;

FIG. 4 is a flowchart illustrating an exemplary process in the detection device according to the first embodiment;

FIG. 5 is a plan view illustrating a first example of an object to be converted that is extracted by the detection device according to the first embodiment;

FIG. 6 is a sub-flowchart illustrating a first example of conversion processing in the detection device according to the first embodiment;

FIG. 7 is a sub-flowchart illustrating a second example of the conversion processing in the detection device according to the first embodiment;

FIG. 8 is a plan view illustrating a second example of the object to be converted that is extracted by the detection device according to the first embodiment;

FIG. 9 is a chart illustrating a correspondence relation between the object and a sound file in the second example of the object to be converted illustrated in FIG. 8;

FIG. 10 is a sub-flowchart illustrating a third example of the conversion processing in the detection device according to the first embodiment;

FIG. 11 is a plan view illustrating a third example of the object to be converted that is extracted by the detection device according to the first embodiment;

FIG. 12 is a chart illustrating a correspondence relation between the object and the sound file in the third example of the object to be converted illustrated in FIG. 11;

FIG. 13 is a sub-flowchart illustrating a fourth example of the conversion processing in the detection device according to the first embodiment;

FIG. 14 is a sectional view schematically illustrating a detection device according to a second embodiment of the present disclosure;

FIG. 15 is a flowchart illustrating an exemplary process in the detection device according to the second embodiment;

FIG. 16 is a plan view illustrating a first example of the object to be converted that is extracted by the detection device according to the second embodiment;

FIG. 17 is a plan view illustrating a second example of the object to be converted that is extracted by the detection device according to the second embodiment;

FIG. 18 is a plan view illustrating a third example of the object to be converted that is extracted by the detection device according to the second embodiment;

FIG. 19 is a sectional view schematically illustrating a detection device according to a third embodiment of the present disclosure;

FIG. 20 is a schematic sectional view of a transparent display;

FIG. 21 is a flowchart illustrating an exemplary process in the detection device according to the third embodiment;

FIG. 22 is a plan view illustrating a first example of the object to be converted that is selected by the detection device according to the third embodiment;

FIG. 23 is a plan view illustrating a second example of the object to be converted that is selected by the detection device according to the third embodiment; and

FIG. 24 is a plan view illustrating a third example of the object to be converted that is selected by the detection device according to the third embodiment.

### DETAILED DESCRIPTION

The following describes modes (embodiments) for carrying out the present disclosure in detail with reference to the drawings. The present disclosure is not limited to the description of the embodiments given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In the present disclosure, in expressing an aspect of disposing another structure on or above a certain structure, a case of simply expressing “on” includes both a case of disposing the other structure immediately on the certain structure so as to contact the certain structure and a case of disposing the other structure above the certain structure with still another structure interposed therebetween, unless otherwise specified.

### First Embodiment

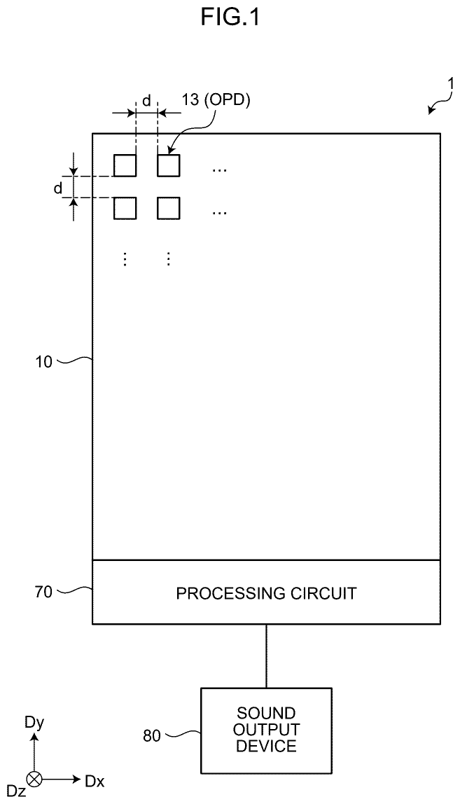

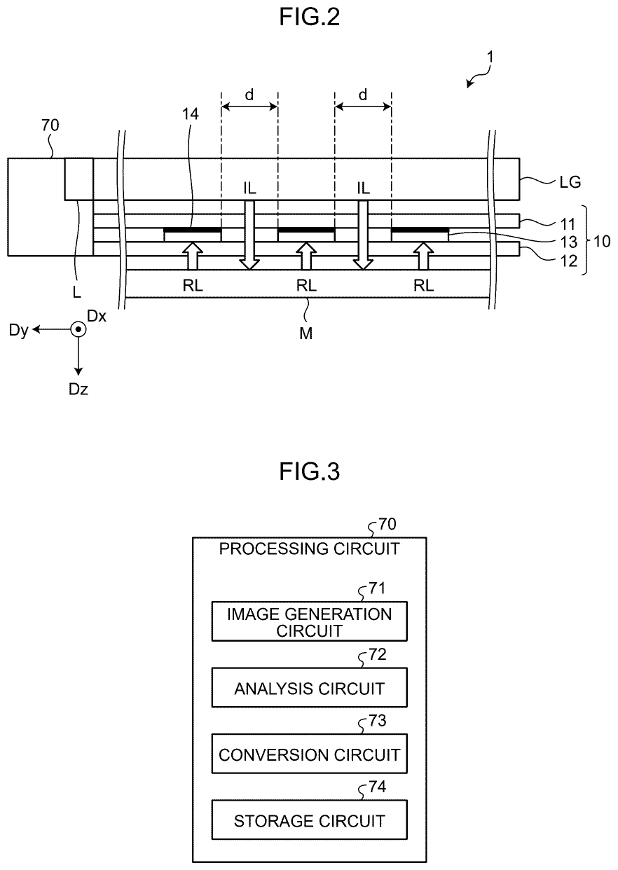

FIG. 1 is a plan view schematically illustrating a detection device 1 according to a first embodiment of the present disclosure. FIG. 2 is a sectional view schematically illustrating the detection device 1 according to the first embodiment.

As illustrated in FIG. 1, the detection device 1 includes an optical sensor 10 and a processing circuit 70. The processing circuit 70 is coupled to a sound output device 80 such as an earphone or a speaker. In the present disclosure, the detection device 1 is a device that, for example, acquires information printed on a sheet-like medium M, such as a paper medium, as an image, and outputs sound information related to the image. In the present disclosure, examples of an object to be converted into the sound information include text information such as sentences and words, and in addition, image information such as illustrations and photographs.

The optical sensor 10 is provided with a plurality of sensor pixels 13 between two opposed substrates 11 and 12. In the present disclosure, the two substrates 11 and 12 are, for example, resin films formed of resin such as transparent polyimide.

In the example illustrated in FIG. 1, the sensor pixels 13 are arranged in a first direction Dx and a second direction Dy, thus being arranged in a matrix having a row-column configuration in plan view. The sensor pixels 13 are not limited to being arranged in this manner, and may be arranged in a staggered manner in plan view.

In the present disclosure, the first direction Dx is one direction in a plane parallel to the substrates 11 and 12. The second direction Dy is one direction in the plane parallel to the substrates 11 and 12 and is a direction orthogonal to the first direction Dx. A third direction Dz is a direction orthogonal to the Dx-Dy plane.

Each of the sensor pixels 13 includes a photodiode. The photodiode outputs a potential corresponding to light emitted thereto. More specifically, the photodiode is an organic photodiode (OPD) using an organic semiconductor.

The processing circuit 70 is provided at one end of the optical sensor 10. The processing circuit 70 in the present disclosure is a component that performs detection timing control and detection processing in the optical sensor 10, processes images acquired by the detection processing, and converts the images into sound. The processing circuit 70 includes, for example, a microcontroller unit (MCU), a random-access memory (RAM), an electrically erasable programmable read-only memory (EEPROM), and a read-only memory (ROM). FIG. 1 illustrates an aspect in which the optical sensor 10 and the processing circuit 70 are integrated, but the optical sensor 10 and the processing circuit 70 can be provided as different components.

In the first embodiment, the detection device 1 includes a light guide plate LG that is placed over the optical sensor 10 in the third direction Dz so as to overlap the optical sensor 10 in plan view, and a light source L provided at one end of the light guide plate LG. In the present disclosure, emission timing of the light source L is controlled by the processing circuit 70.

The light guide plate LG is a film that has a light-transmitting property and is formed of a polymer compound, such as cellulose triacetate (TAC).

Examples of the light source L include, but are not limited to, inorganic light-emitting diodes (LEDs), organic electroluminescent (EL) diodes (organic light-emitting diodes (OLEDs)), and semiconductor laser diodes (LDs).

A light-blocking layer 14 is provided on a surface on the light guide plate LG side of each of the sensor pixels 13. An opening d is provided between the adjacent sensor pixels 13. The sheet-like medium M is located so as to be in contact with or in proximity to one surface of the optical sensor 10 opposite to another surface of the optical sensor 10 on which the light guide plate LG is provided (hereinafter, the one surface is also referred to as a “detection surface of the optical sensor 10”).

Light emitted from the light source L propagates in the light guide plate LG and illuminates the optical sensor 10. Incident light IL from the light guide plate LG incident on the optical sensor 10 passes through the opening d and reaches the sheet-like medium M. Reflected light RL reflected by the sheet-like medium M enters the sensor pixels 13, and an electrical signal corresponding to the reflected light RL is output from each of the sensor pixels 13.

The processing circuit 70 controls the detection timing in the optical sensor 10 and the emission timing of the light source L. Based on the electrical signal of each of the sensor pixels 13 output from the optical sensor 10, the processing circuit 70 acquires an image on the surface of the sheet-like medium M (for example, a printed surface of a printed book) placed opposite the detection surface of the optical sensor 10 so as to be in contact therewith or in proximity thereto. This operation can reduce the difficulty of a visually impaired person in acquiring an image to be converted into sound.

The reflected light RL reflected by the sheet-like medium M passes through the opening d of the optical sensor 10, so that visually unimpaired people can see the surface of the sheet-like medium M (such as the printed surface of the printed book) corresponding to the reflected light transmitted through the optical sensor 10. With this configuration, for example, the visually unimpaired person supporting the visually impaired person can accurately set the position of an image acquisition area of the optical sensor 10 with respect to the image to be converted to sound on the surface of the sheet-like medium M.

FIG. 3 is a block diagram illustrating a configuration example of the processing circuit 70. In the present disclosure, components and processes for executing various types of timing control and detection processing in the optical sensor 10 will not be described, and components and processes for executing image generation processing, image recognition processing, and sound conversion processing will be described.

As illustrated in FIG. 3, the processing circuit 70 includes an image generation circuit 71, an analysis circuit 72, a conversion circuit 73, and a storage circuit 74 as components to execute the image generation processing, the image recognition processing, and the sound conversion processing.

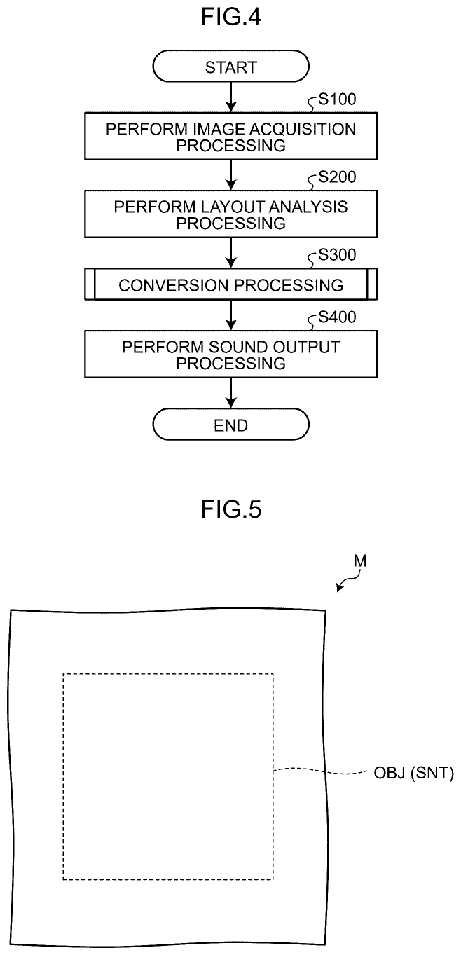

FIG. 4 is a flowchart illustrating an exemplary process in the detection device 1 according to the first embodiment.

The image generation circuit 71 binarizes a detection value of each of the sensor pixels 13 acquired from the optical sensor 10 to acquire an image including the object to be converted (image acquisition processing, Step S100). The image acquisition processing in the image generation circuit 71 is not limited to the binarization processing.

The analysis circuit 72 performs layout analysis on the image acquired by the image generation circuit 71 to objectify the image, and extracts an image to be converted into sound (hereinafter also referred to as an “object to be converted OBJ”) from the objectified image (layout analysis processing, Step S200). In the present disclosure, examples of the object to be converted that is extracted by the layout analysis, include a sentence (hereinafter, also referred to as an “object OBJ (SNT)”), a word (hereinafter, also referred to as an “object OBJ (WORD)”), and an image (hereinafter, also referred to as an “object OBJ (IMG)”) other than textual information.

The conversion circuit 73 is a component to convert the object to be converted OBJ that is extracted by the analysis circuit 72, into the sound (conversion processing, Step S300). The storage circuit 74 stores therein computer programs and data for converting the object to be converted OBJ that is extracted by the analysis circuit 72, into the sound.

FIG. 5 is a plan view illustrating a first example of the object to be converted OBJ that is extracted by the detection device 1 according to the first embodiment. FIG. 5 illustrates a situation in which the object OBJ (SNT) is extracted as the object to be converted OBJ within the image acquisition area of the optical sensor 10, and sound synthesis is performed on the textual information on the object OBJ (SNT) to produce sound (e.g., voice or speech) from the textual information.

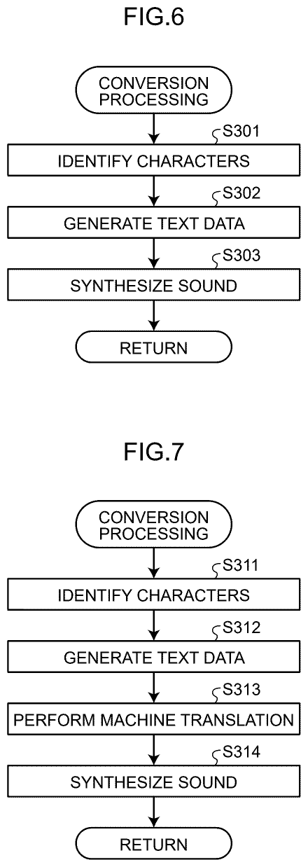

FIG. 6 is a sub-flowchart illustrating a first example of the conversion processing in the detection device 1 according to the first embodiment.

In the conversion processing illustrated in FIG. 6, the conversion circuit 73 performs optical character recognition (OCR) processing and sound synthesis processing on the object OBJ (SNT). Specifically, the conversion circuit 73 performs character identification processing on the object OBJ (SNT) (Step S301), generates text data (Step S302), synthesizes sound (e.g., voice or speech) from the generated text data (Step S303), and outputs the sound from the sound output device 80 (Step S400 in FIG. 4).

FIG. 7 is a sub-flowchart illustrating a second example of the conversion processing in the detection device 1 according to the first embodiment. FIG. 7 illustrates a situation in which the text data (for example, in Japanese) is machine-translated into another language (for example, English).

In the conversion processing illustrated in FIG. 7, the conversion circuit 73 performs the OCR processing, the machine translation processing, and the sound synthesis processing on the object OBJ (SNT). Specifically, the conversion circuit 73 performs the character identification processing on the object OBJ (SNT) (Step S311), generates the text data (Step S312), performs the machine translation processing on the generated text data (Step S313), synthesizes sound (e.g., voice or speech) from the text data translated into the other language (Step S314), and outputs the sound from the sound output device 80 (Step S400 in FIG. 4).

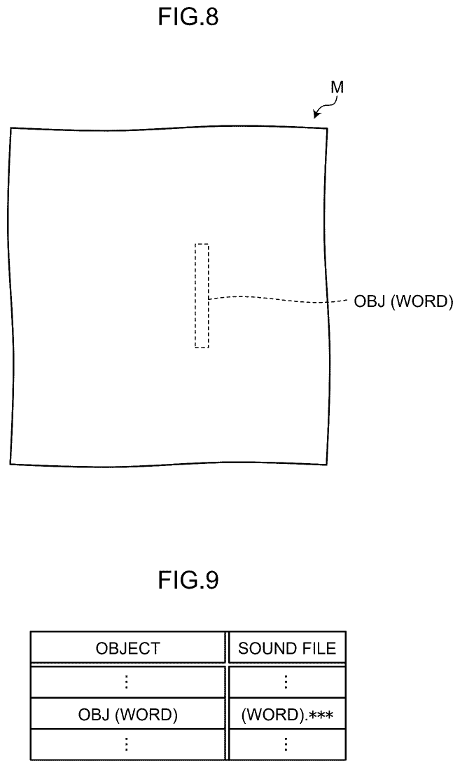

FIG. 8 is a plan view illustrating a second example of the object to be converted OBJ that is extracted by the detection device 1 according to the first embodiment. FIG. 8 illustrates a situation in which the object OBJ (WORD) is extracted as the object to be converted OBJ within the image acquisition area of the optical sensor 10, and a sound file corresponding to the object OBJ (WORD) is read and played. The sound file corresponding to the object OBJ (WORD) is stored in the storage circuit 74 in advance.

FIG. 9 is a chart illustrating a correspondence relation between the object OBJ (WORD) and a sound file “(WORD).***” in the second example of the object to be converted OBJ illustrated in FIG. 8. In the situation illustrated in FIG. 8, for example, a name of an animal or a name of a musical instrument is registered as the object OBJ (WORD), and sound of the animal or sound of the musical instrument corresponding to the object OBJ (WORD) is registered as the sound file “(WORD).***” corresponding to the object OBJ (WORD). The present disclosure is not limited by the file format of the sound file “(WORD).***”.

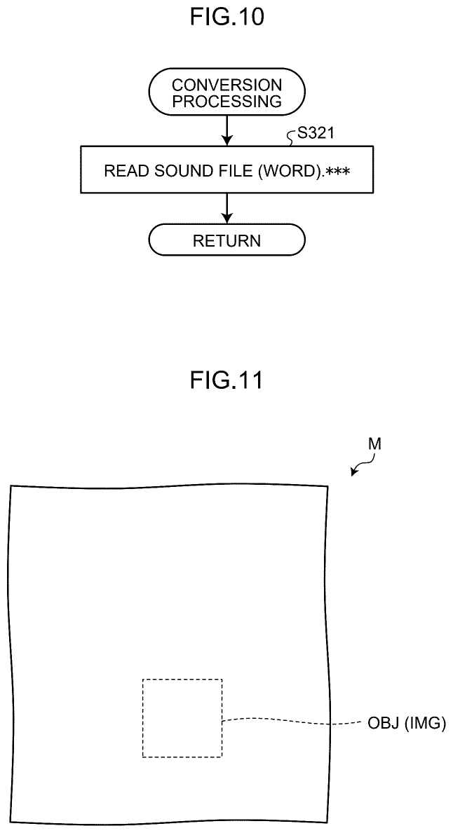

FIG. 10 is a sub-flowchart illustrating a third example of the conversion processing in the detection device 1 according to the first embodiment.

In the conversion processing illustrated in FIG. 10, the conversion circuit 73 reads the sound file “(WORD).***” corresponding to the object OBJ (WORD) from the storage circuit 74 (Step S321), and outputs the sound from the sound output device 80 (Step S400 in FIG. 4).

FIG. 11 is a plan view illustrating a third example of the object to be converted OBJ that is extracted by the detection device 1 according to the first embodiment. FIG. 11 illustrates a situation in which the object OBJ (IMG) is extracted as the object to be converted OBJ within the image acquisition area of the optical sensor 10, and a sound file corresponding to the object OBJ (IMG) is read and played. In the situation illustrated in FIG. 11, the sound file corresponding to the object OBJ (IMG) is stored in the storage circuit 74 in advance.

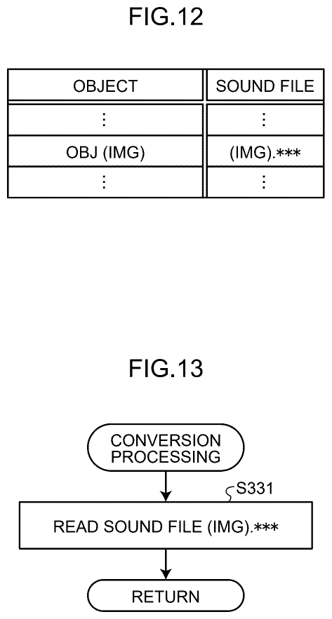

FIG. 12 is a chart illustrating a correspondence relation between the object OBJ (IMG) and the sound file “(IMG).***” in the third example of the object to be converted OBJ illustrated in FIG. 11. In the situation illustrated in FIG. 11, for example, an image of a painting is registered as the object OBJ (IMG), and a music file corresponding to the image of the object OBJ (IMG) is registered as the sound file “(IMG).***” corresponding to the object OBJ (IMG). The present disclosure is not limited by the file format of the sound file “(IMG).***”.

FIG. 13 is a sub-flowchart illustrating a fourth example of the conversion processing in the detection device 1 according to the first embodiment.

In the conversion processing illustrated in FIG. 13, the conversion circuit 73 reads the sound file “(IMG).***” corresponding to the object OBJ (IMG) from the storage circuit 74 (Step S331), and outputs the sound from the sound output device 80 (Step S400 in FIG. 4).

### Second Embodiment

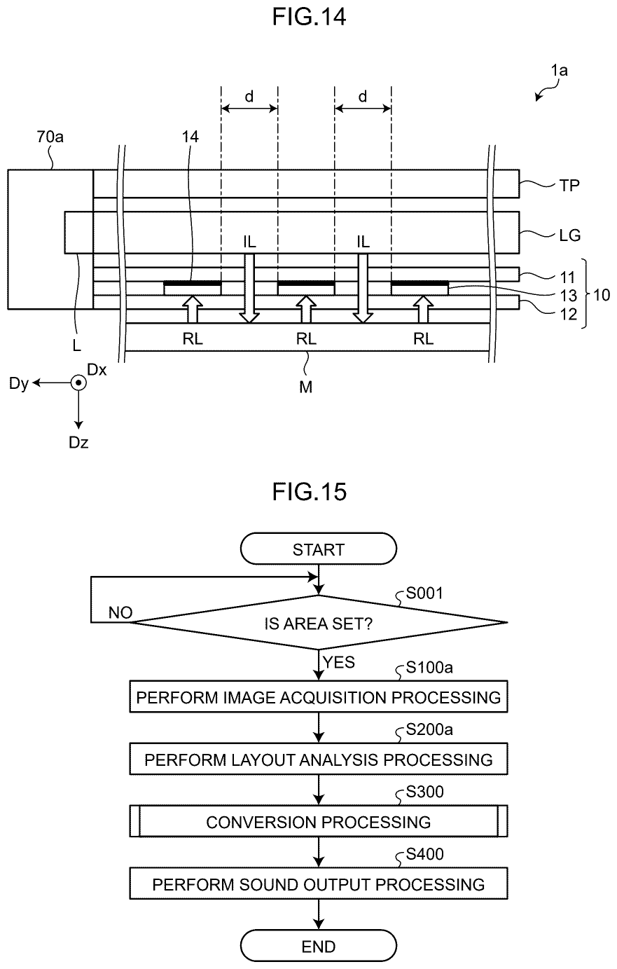

FIG. 14 is a sectional view schematically illustrating a detection device la according to a second embodiment of the present disclosure. In the second embodiment, a configuration will be described that allows the visually unimpaired person to specify an area within the image acquisition area of the optical sensor 10 for extracting the object to be converted. The following description may omit the same description as that in the first embodiment.

In the second embodiment, the detection device la includes a touch sensor TP that is disposed over the optical sensor 10 in the third direction Dz so as to overlap in plan view. The touch sensor TP is a touch detection device (touch panel) that detects an object to be detected in contact with the detection surface (hereinafter, also referred to as “touch detection”). In the present disclosure, the touch sensor TP performs, for example, capacitive (self-capacitive or mutual capacitive) touch detection. FIG. 14 illustrates a configuration with the touch panel (touch sensor TP) mounted on top of the light guide plate LG.

A processing circuit 70a in the second embodiment is a component that performs the detection timing control and the detection processing in the touch sensor TP in addition to the processing described in the first embodiment. In the present disclosure, components and processing for executing the detection timing control and the detection processing in the touch sensor TP will not be described.

FIG. 15 is a flowchart illustrating an exemplary process in the detection device la according to the second embodiment. In the second embodiment, the processing circuit 70a determines whether the area for extracting the object to be converted OBJ is set by the touch sensor TP (Step S001). When the area for extracting the object to be converted OBJ is not set (No at Step S001), the process at Step S001 is repeated. When the area for extracting the object to be converted OBJ is set (Yes at Step S001), the processing circuit 70a performs the same processing as in the first embodiment described above within the area set by the touch sensor TP. Thus, it is possible to specify the area including the object to be converted OBJ that is to be extracted.

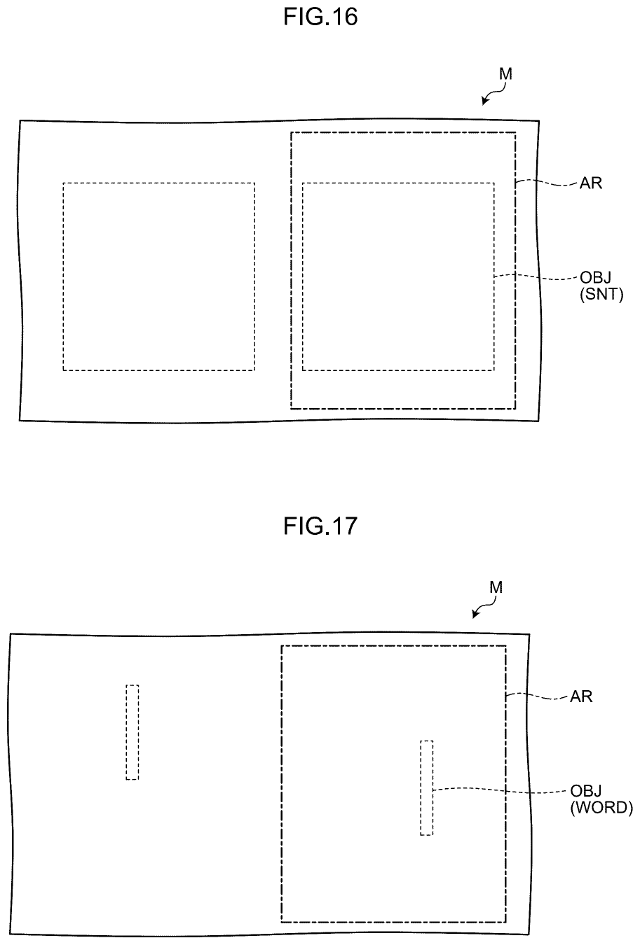

FIG. 16 is a plan view illustrating a first example of the object to be converted OBJ that is extracted by the detection device la according to the second embodiment. In FIG. 16, an image including the object to be converted is acquired in an area AR set by the touch sensor TP (image acquisition processing Step S100a); the acquired image in the area AR is objectified by the layout analysis; and the object OBJ (SNT) is extracted as the object to be converted OBJ (layout analysis processing Step S200a).

In the conversion processing illustrated in FIG. 6, the conversion circuit 73 performs the character identification processing on the object OBJ (SNT) (Step S301), generates the text data (Step S302), synthesizes sound (e.g., voice or speech) from the generated text data (Step S303), and outputs the sound from the sound output device 80 (Step S400 in FIG. 4).

Alternatively, in the conversion processing illustrated in FIG. 7, the conversion circuit 73 performs the character identification processing on the object OBJ (SNT) (Step S311), performs the machine translation processing on the generated text data (Step S313), synthesizes sound (e.g., voice or speech) from the text data translated into another language (Step S314), and outputs the sound from the sound output device 80 (Step S400 in FIG. 4).

FIG. 17 is a plan view illustrating a second example of the object to be converted OBJ that is extracted by the detection device la according to the second embodiment. In FIG. 17, an image including the object to be converted is acquired in an area AR set by the touch sensor TP (image acquisition processing Step S100a); the acquired image in the area AR is objectified by the layout analysis; and the object OBJ (WORD) is extracted as the object to be converted OBJ (layout analysis processing Step S200a).

Then, in the conversion processing illustrated in FIG. 10, the conversion circuit 73 reads the sound file “(WORD).***” corresponding to the object OBJ (WORD) from the storage circuit 74 (Step S321), and outputs the sound from the sound output device 80 (Step S400 in FIG. 4).

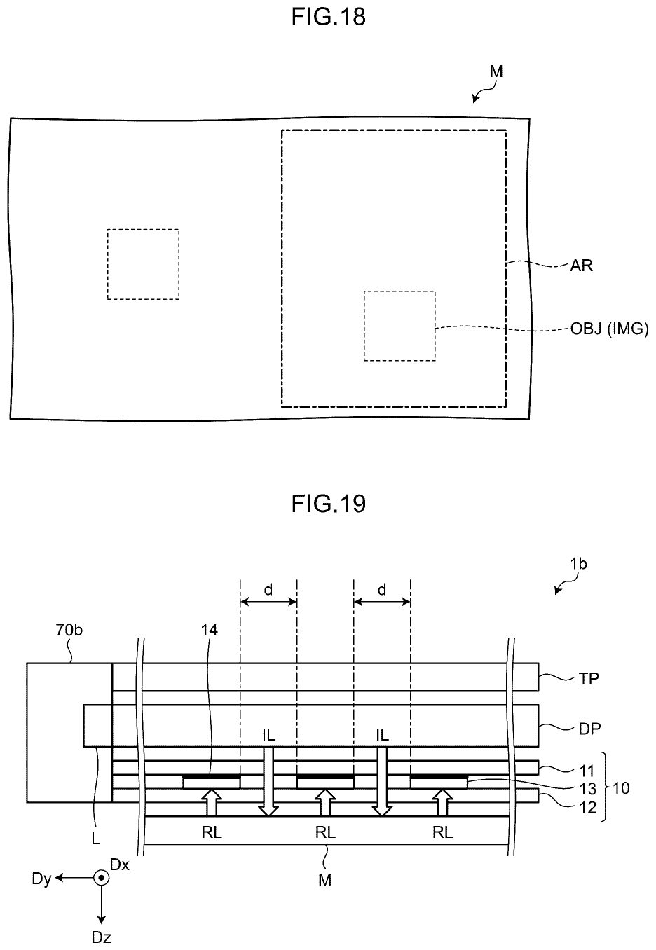

FIG. 18 is a plan view illustrating a third example of the object to be converted OBJ that is extracted by the detection device 1a according to the second embodiment. In FIG. 18, an image including the object to be converted is acquired in an area AR set by the touch sensor TP (image acquisition processing Step S100a); the acquired image in the area AR is objectified by the layout analysis; and the object OBJ (IMG) is extracted as the object to be converted OBJ (layout analysis processing Step S200a).

Then, in the conversion processing illustrated in FIG. 13, the conversion circuit 73 reads the sound file “(IMG).***” corresponding to the object OBJ (IMG) from the storage circuit 74 (Step S331), and outputs the sound from the sound output device 80 (Step S400 in FIG. 4).

### Third Embodiment

FIG. 19 is a sectional view schematically illustrating a detection device 1b according to a third embodiment of the present disclosure. In the third embodiment, a configuration will be described that allows the visually unimpaired person to select the object to be converted within the image acquisition area of the optical sensor 10. The following description may omit the same description as that in the first or second embodiment.

In the third embodiment, the detection device 1b includes a transparent display DP that is disposed over the optical sensor 10 in the third direction Dz so as to overlap in plan view, instead of the light guide plate LG. FIG. 19 illustrates what is called an on-cell configuration in which the touch sensor TP (touch panel) is mounted on top of the transparent display DP.

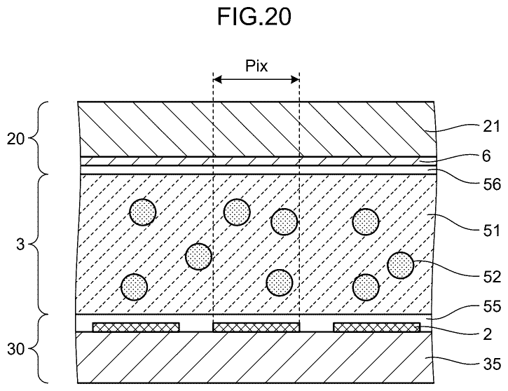

FIG. 20 is a schematic sectional view of the transparent display DP.

The transparent display DP includes a first substrate 30 and a second substrate 20 facing each other, and a liquid crystal 3 enclosed between the two substrates.

The first substrate 30 includes a light-transmitting substrate 35, a pixel electrode 2, and an insulating layer 55. The pixel electrode 2 is individually provided for each pixel Pix. The second substrate 20 includes a light-transmitting substrate 21, a common electrode 6, and an insulating layer 56.

In the present disclosure, the liquid crystal 3 is a polymer-dispersed liquid crystal (PDLC). In other words, in the present embodiment, a display panel DISP is a liquid crystal panel in which the polymer-dispersed liquid crystal is enclosed. Specifically, the liquid crystal 3 includes a bulk 51 and fine particles 52. The fine particles 52 change in orientation in the bulk 51 according to a potential difference between the pixel electrode 2 and the common electrode 6. The scattering state of the liquid crystal 3 for each pixel Pix is controlled by individually controlling the potential of the pixel electrode 2 for each pixel Pix.

Although FIG. 20 illustrates an example in which the pixel electrode 2 and the common electrode 6 are arranged so as to face each other with the liquid crystal 3 interposed therebetween, the display panel DISP may be configured such that the pixel electrode 2 and the common electrode 6 are provided on one substrate and the orientation is changed by an electric field generated by the pixel electrode 2 and the common electrode 6 to control the scattering state of liquid crystal 3.

A processing circuit 70b in the third embodiment is a component that performs display timing control and display processing in the transparent display DP in addition to the processing described in the second embodiment. In the present disclosure, components and processes for executing the display timing control and the display processing in the transparent display DP will not be described.

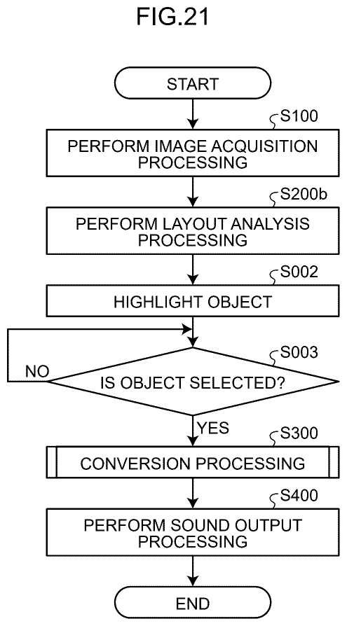

FIG. 21 is a flowchart illustrating an exemplary process in the detection device 1b according to the third embodiment. In the third embodiment, the image acquired by the image generation circuit 71 is objectified by the layout analysis processing (layout analysis processing S200b), and the image objectified by the layout analysis processing is highlighted on the display DP (Step S002). This operation makes the object to be converted OBJ explicitly selectable. Exemplary aspects of highlighting the image objectified by the layout analysis processing on the display DP includes, for example, an aspect in which a line surrounding the objectified image is displayed on the display DP, and an aspect in which a schematic image along the objectified image is displayed on the display DP.

The processing circuit 70b determines whether any of the objects highlighted on the display DP has been selected as the object to be converted OBJ by the touch sensor TP (Step S003). If no object is selected (No at Step S003), repeats the processing at Step S003. If the object to be converted OBJ is selected (Yes at Step S003), the conversion circuit 73 performs the same processing as in the first embodiment described above, on the object to be converted OBJ that is selected by the touch sensor TP.

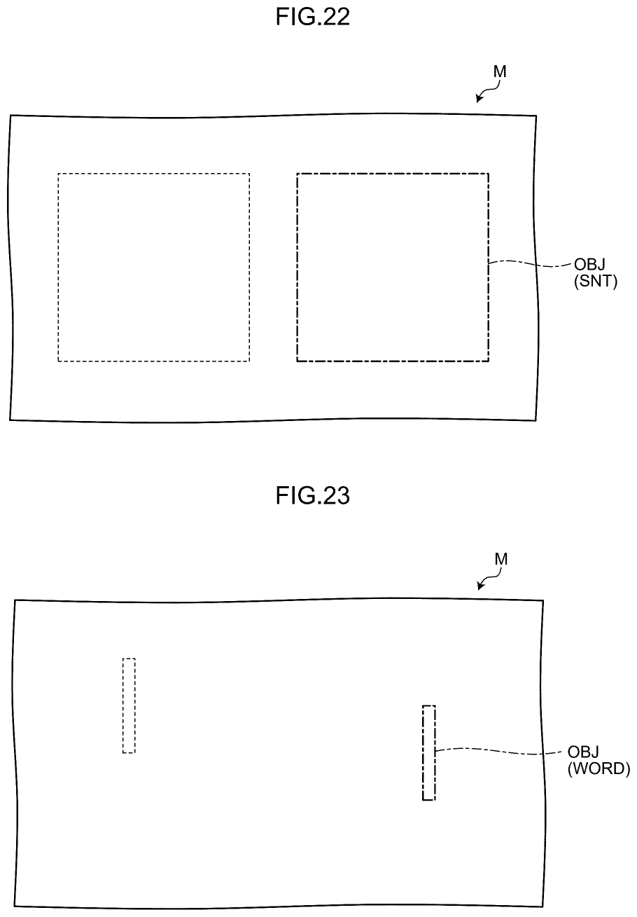

FIG. 22 is a plan view illustrating a first example of the object to be converted OBJ that is selected by the detection device 1b according to the third embodiment. FIG. 22 illustrates a situation in which the object OBJ (SNT) indicated by a long dashed short dashed line is selected, as the object to be converted OBJ, from among objects highlighted on the transparent display DP.

In the conversion processing illustrated in FIG. 6, the conversion circuit 73 performs the character identification processing on the object OBJ (SNT) (Step S301), generates the text data (Step S302), synthesizes sound (e.g., voice or speech) from the generated text data (Step S303), and outputs the sound from the sound output device 80 (Step S400 in FIG. 4).

Alternatively, in the conversion processing illustrated in FIG. 7, the conversion circuit 73 performs the character identification processing on the object OBJ (SNT) (Step S311), performs the machine translation processing on the generated text data (Step S313), synthesizes sound (e.g., voice or speech) from the text data translated into another language (Step S314), and outputs the sound from the sound output device 80 (Step S400 in FIG. 4).

FIG. 23 is a plan view illustrating a second example of the object to be converted OBJ that is selected by the detection device 1b according to the third embodiment. FIG. 23 illustrates a situation in which the object OBJ (WORD) indicated by a long dashed short dashed line is selected, as the object to be converted OBJ, from among objects highlighted on the transparent display DP.

In the conversion processing illustrated in FIG. 10, the conversion circuit 73 reads the sound file “(WORD).***” corresponding to the object OBJ (WORD) from the storage circuit 74 (Step S321), and outputs the sound from the sound output device 80 (Step S400 in FIG. 4).

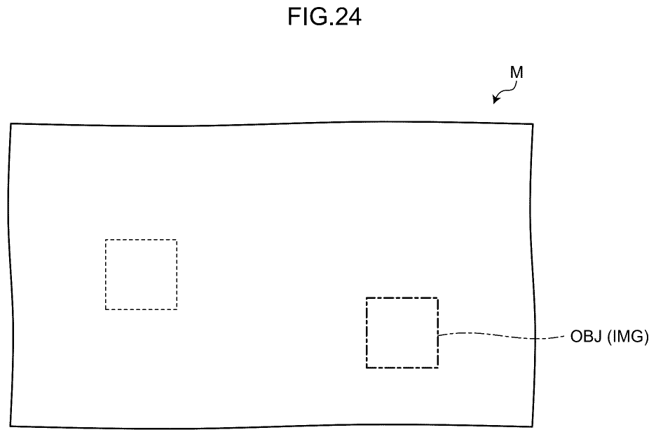

FIG. 24 is a plan view illustrating a third example of the object to be converted OBJ that is selected by the detection device 1b according to the third embodiment. FIG. 24 illustrates a situation in which the object OBJ (IMG) indicated by a long dashed short dashed line is selected, as the object to be converted OBJ, from among objects highlighted on the transparent display DP.

In the conversion processing illustrated in FIG. 13, the conversion circuit 73 reads the sound file “(IMG).***” corresponding to the object OBJ (IMG) from the storage circuit 74 (Step S331), and outputs the sound from the sound output device 80 (Step S400 in FIG. 4).

While the preferred embodiments of the present disclosure have been described above, the present disclosure is not limited to the embodiments described above. The content disclosed in the embodiments is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and changes of the components can be made without departing from the gist of the embodiments described above.

What is claimed is:

1. A detection device comprising:
a light-transmitting optical sensor in which a plurality of sensor pixels are arranged in a planar configuration; and
a processing circuit configured to acquire an image on a sheet-like medium in contact with or in proximity to one surface of the optical sensor and generate sound information based on the image.

2. The detection device according to claim 1, wherein each of the sensor pixels comprises an organic photodiode (OPD).

3. The detection device according to claim 2, comprising a touch sensor provided so as to overlap the optical sensor and configured to allow the sheet-like medium to be viewed from another surface of the optical sensor.

4. The detection device according to claim 3, wherein the processing circuit is configured to acquire the image in an area selected by the touch sensor.

5. The detection device according to claim 3, wherein the processing circuit is configured to
perform layout analysis on the image on the sheet-like medium to objectify the image and
convert an image selected from the objectified image by the touch sensor into the sound information.

6. The detection device according to claim 1, comprising:
a light guide member provided so as to overlap the optical sensor and configured to allow the sheet-like medium to be viewed from the other surface of the optical sensor; and
a light source provided at one end of the light guide member.

7. The detection device according to claim 5, comprising:
a transparent display provided so as to overlap the optical sensor and configured to allow the sheet-like medium to be viewed from the other surface of the optical sensor; and
a light source provided at one end of the transparent display, wherein
the transparent display is configured to highlight the image objectified by the processing circuit.

8. The detection device according to claim 7, wherein the transparent display comprises a polymer-dispersed liquid crystal (PDLC) enclosed between two opposed substrates.
